(19) United States
(12) Patent Application Publication
(10) Pub. No.: US 2005/0078741 A1
(43) Pub. Date: Apr. 14, 2005

(54) Apparatus and method for detecting a timing error in a mobile communication system

(76) Inventors: Hun-Geun Song, (US); Yong-Suk Moon, (US); Hyun-Seok Oh, (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/913,503

(22) Filed: Aug. 9, 2004

(30) Foreign Application Priority Data
Aug. 9, 2003 (KR) 55198/2003

(51) Int. Cl. H04B 1/707

(52) U.S. Cl. 375/148

(57) ABSTRACT

An apparatus and method for detecting the reception timing of a received signal in a mobile communication system are provided. Two time points having the same energy, earlier and later than the received signal, are detected. The energy ratio between other time points spaced from the two time points by the same interval is calculated and it is determined whether the energy ratio falls into a predetermined rage. If the energy ratio is within the range, the received signal is considered to have no effects from an interference signal or a neighboring signal.

### PRIORITY

This application claims the benefit under 35 U.S.C. § 119(a) of an application entitled “Apparatus and Method for Detecting Timing Error in a Mobile Communication System” filed in the Korean Intellectual Property Office on August 9, 2003 and assigned Serial No. 2003-55198, the entire contents of which are incorporated herein by reference.

### BACKGROUND OF THE INVENTION

1. Field of the Invention

The present invention relates generally to a rake receiver in a mobile communication system. In particular, the present invention relates to an apparatus and method for improving the performance of a time tracker in a rake receiver.

2. Description of the Related Art

Due to the rapid development of mobile communication systems and the rapid growth of data traffic serviced in mobile communication systems, 3^{rd} generation mobile communication systems have been developed to transmit data at higher rates. Wideband Code Division Multiple Access (WCDMA) and Code Division Multiple Access 2000 (CDMA2000) have been selected as the 3^{rd} generation radio access standards in Europe and North America, respectively. WCDMA utilizes an asynchronous base station operation, while CDMA2000 utilizes a synchronous base station operation. The mobile communication systems are typically configured so that a plurality of user equipments (UEs) communicate with a Node B. During high-speed data transmission, fading on a radio channel causes distortion in a received signal. The fading phenomenon reduces the amplitude of the received signal by several to tens of decibels. Without compensating for the distortion at demodulation for the received signal, the distortion leads to information errors in data transmitted from a transmitter, thereby decreasing a quality of service (QoS). Thus, to transmit data at high rates without decreasing the QoS, fading must be overcome. For this purpose, a variety of diversity schemes are used.

Typically, a CDMA communication system uses a rake receiver that receives a channel signal using diversity, exploiting its delay spread. Receive diversity is applied to the rake receiver, for reception of multipath signals. Each finger of the rake receiver is assigned to one of the signal paths and demodulates data from the assigned signal path.

However, if a delay spread is below a threshold, the rake receiver does not work.

As described above, a transmitted signal having different power levels arrives at a UE via different paths that have different time delays. To convert the multipath signals to a signal having sufficient power, the received signals must be combined. Hereinbelow, data transmission and reception in a conventional mobile communication system using a direct spreading scheme will be described.

User data aₙ is spectrum-spread with effective spreading sequences including a spreading code and a scrambling code. The spread signal is transmitted on a radio channel through a pulse-type filter. A baseband model of a transmitted signal for a UE is expressed as

$$s ( t ) = {\sum }_{m = ∞}^{∞} {a}_{n} {\sum }_{k = 0}^{{N}_{c} - 1} {d}_{{nN}_{c}} {+}_{k} g ( t - nT - {kT}_{c} ) \qquad ( 1 )$$

where sₜ is the transmitted signal, N_{c} is a spreading component, g(t) is a root-raised cosine pulse with a roll-off factor of 0.22, T is a symbol duration, and T_{c} is a chip duration, equaling T/N_{c}. The transmitted signal arrives at a receiver from L paths on a multipath channel in the mobile communication system. The following equation represents the impulse response of the channel.

$$h ( τ ) = {\sum }_{l = 0}^{L - 1} {C}^{l} δ ( τ - {τ}_{1} ) \qquad ( 2 )$$

where tᵢ is the time delay of each path and C¹ is a complex attenuation component. C of C¹ is a complex value.

Additive White Gaussian Noise (AWGN) is added to the received transmitted signal which in the form that

$$r ( l ) = {\sum }_{i = 0}^{L - 1} {C}^{l} {\sum }_{m = - ∞}^{∞} {a}_{n} {\sum }_{k = 0}^{N - 1} {d}_{{nN}_{c}} {+}_{k} g ( t - nT - {kT}_{o} - {τ}_{1} ) + n ( t ) \qquad ( 3 )$$

The received signal is filtered in the same root-raised cosine filter as used in the transmitter. The filter output is

$$z ( t ) = {\sum }_{l = 0}^{L - 1} {C}^{l} {\sum }_{m = - ∞}^{∞} {a}_{n} {\sum }_{k = 0}^{{N}_{c} - 1} {d}_{{nN}_{c} + k} {R}_{g} ( t - nT - {kT}_{c} - {τ}_{1} ) + {n}^{′} ( t ) \qquad ( 4 )$$

where R_{g}(t) is an auto-correlation function of g(t) and n′(t) is noise and interference signals from other users that have passed through the filter, equaling n(t)·p*(t)·R_{g}(t) is determined by

$${R}_{g} ( t ) = {\int }_{- ∞}^{∞} {g}^{M} ( τ ) g ( t + τ ) ⅆ τ \qquad ( 5 )$$

As in a conventional mobile communication system, it is assumed that the receiver is aware that a known pilot symbol is transmitted on a pilot channel. Let the pilot symbol on the pilot channel be denoted by A. Then,

$$s ( t ) = A {\sum }_{k = - ∞}^{∞} {d}_{k} g ( t - k {T}_{c} ) \qquad ( 6 )$$

In the mobile communication system, multiple paths vary with time or the position of a UE and relative time differences between the multiple paths vary with the mobile velocity and radio environment of the receiver. The number of multiple paths involved in the communication of the UE is not fixed. Because of the receiver's limited time resolution ability and the nature of the radio channel, a reduced number of multiple paths may be used.

Traditionally, if a received signal is simple in structure, an early late timing error detector (EL TED) is used to thereby increase the efficiency. The EL TED detects a timing by applying the energy difference between signals spaced at a 1/2 chip interval to the input of a filter.

Referring to FIG. 1, a conventional TED will be described in detail. A multiplexer (MUX) 100 multiplexes a received signal. A scrambler 110 receives a signal 1/2 chip earlier than the received signal and a scrambler 112 receives a signal 1/2 chip later than the received signal. The 1/2-chip earlier signal and the 1/2-chip later signal are expressed respectively as

$$\begin{matrix}{r}_{g + ( 1 / 2 )} \approx r [ ( s + {ɛ}_{σ} + \frac{1}{2} ) {T}_{c} ] - C \cdot {R}_{g} ( ( s + {ɛ}_{s} + \frac{1}{2} ) {T}_{c} ] + {n}_{s + ( 1 / 2 ) \\} \\ and & ( 7 ) \\ {r}_{g - ( 1 / 2 )} \approx r [ ( s + {ɛ}_{s} - \frac{1}{2} ) {T}_{c} ] - C \cdot {R}_{s} ( ( s + {ɛ}_{s} - \frac{1}{2} ) {T}_{c} ] + {n}_{g - ( 1 / 2 )} & ( 8 )\end{matrix}$$

where εₛ is a chip timing error in a chip S and n has the same meaning of n of Eq. (3). Averagers 120 and 122 receive a scrambled signal from the scrambler 110, and averagers 124 and 126 receive a scrambled signal from the scrambler 112. The averagers 120 to 126 calculate

$$\begin{matrix}{\tilde{z}}_{s}^{+} = {d}_{k}^{2} \cdot \frac{1}{N} {\sum }_{1}^{N} {r}_{s + 1 / 2} + {\tilde{n}}_{s + 1 / 2} \\ and & ( 9 ) \\ {\tilde{z}}_{s}^{-} = {d}_{k}^{2} \cdot \frac{1}{N} {\sum }_{1}^{N} {r}_{s - 1 / 2} + {\tilde{n}}_{s - 1 / 2} & ( 10 )\end{matrix}$$

The averages output from the averagers 120 to 126 are applied to squarers 130 to 136, respectively. An adder 140 adds the outputs of the squaers 130 and 132, and an adder 142 adds the outputs of the squaers 134 and 136. A subtractor 150 calculates the difference between the outputs of the adders 140 and 142 by
eₛ₌|\tilde{z}ₛ⁺|²−|\tilde{z}ₛ⁻|² (11)
which includes squared noise.

The difference eₛ is input to a loop filter 160. The above equations (7) to (11) are computed on the assumption that the received signal is flat-faded. FIG. 2 illustrates a transmitted signal from a transmitter received at a receiver. As noted from Eq. (11), the energy of the 1/2-chip earlier signal is compared with that of the 1/2-chip later signal. If they are equal, the receiver detects a signal received at the same time when the transmitter transmits the signal. However, the transmitted signal usually takes some time to arrive at the receiver. Hence, the 1/2-chip later signal has a greater energy than the 1/2-chip earlier signal. In this case, the receiver detects two time points having the same energy value by adjusting chip positions and detects a received signal in the mean of the two time points.

Yet, an S curve observed using eₛ under a multipath environment is very different from a typical S curve. The effects of eₛ and multipath-caused changes are demonstrated on the S curve. The operation of the receiver under the multipath environment will be described below.

FIG. 3 is a graph illustrating reception of a transmitted signal from multiple paths, particularly two paths. Referring to FIG. 3, curves 101 and 103 represent two received signals and a curve 102 represents a signal whose energy is the sum of the energies of the two received signals. A problem encountered with the conventional EL TED will be described with reference to FIG. 3. According to Eq. (4), the root-raised cosine filter output of a k^{th} sample is

$${x}_{k} = x ( kT ) = re \{ {{\hat{a}}^{*}}_{k} {{\hat{c}}^{*}}_{\hat{k}} {\sum }_{j = kN}^{( k + 1 ) {N}_{c} - 1} ( z ( j {T}_{c} + {T}_{c} / 2 + \hat{τ} ) - z ( j {T}_{c} - {T}_{c} / 2 + \hat{τ} ) ) {ⅆ}_{j}^{*} \} \qquad ( 12 )$$

where âₖ* denotes a common pilot channel and ĉₖ* is the channel estimation value of the k^{th} symbol. Eq. (12) is based on the assumption that the channel coefficient and user data symbols of the k^{th} sample are known. This equation is viable under a flat-fading environment but results in performance degradation under the multipath environment. The cause of the performance degradation in the multipath environment will be described in connection with the following equations. A signal on an S curve of the EL TED is determined as
S(τ−\hat{τ})=R_{g}(T_{c}/2+\hat{τ}−τ)−R_{g}(−T_{c}/2+\hat{τ}−τ) (13)

A channel estimation value obtained from the pilot channel under the multipath environment is

$$E [ {x}_{n} \vert C ] E [ \vert a {\vert}^{2} ] Re \{ {\vert {c}_{m} \vert}^{2} S ( {τ}_{m} - {\hat{τ}}_{m} ) \} + {E [ \vert a \vert ]}^{2} Re \{ {c}_{m}^{*} {\sum }_{l = 0 … {N}_{p} - 1 , l + m}^{} {C}^{l} s ( {τ}_{l} - {\hat{τ}}_{m} ) \} \qquad ( 14 )$$

The first part of the right term in Eq. (14) represents a desired signal component and the last part represents a multipath-incurred low-frequency interference signal. As illustrated in FIG. 3, two signals are received. The conventional EL TED has a problem with the last part of Eq. (14). As stated earlier, the last part of Eq. (14) is eliminated in the case of flat fading, allowing a normal operation. On the other hand, if the channel is not flat-faded, that is, a neighboring signal component is received within a predetermined chip range, the neighboring signal component acts as an interference signal to the earlier and later parts of the received signal, as illustrated in FIG. 3. In FIG. 3, the mean between two time points having the same energy value in the curve 102 is different from the peak of the curve 101. As a result, multipath signals each serve as interference in energy estimation of earlier and later parts of other signals, thereby decreasing performance. Thus, the conventional EL TED cannot discriminate neighboring paths from one another, thereby decreasing performance.

In general, a line of sight (LOS) signal having higher energy and reflected signals are received from multiple paths at the same time in a radio environment. Particularly when the received signals differ in energy considerably but not much in path, the above-described problem becomes more serious. The problem leads to system overload on the side of a Node B. That is, a UE requests the Node B to transmit signals at a high power level in order to achieve a target signal-to-interference ratio. Because the interference components are low-frequency components, a slow processing UE is highly likely to experience the interference. Especially when data is received at high rate in an indoor environment, the interference signal affects the resolution of fingers as noted from Eq. (14). Consequently, performance is decreased. In this context, there is a need for a method of accurately estimating multipath signal components with approximate spread delays.

### SUMMARY OF THE INVENTION

An object of the present invention is to substantially solve at least the above problems and disadvantages and to provide at least the advantages below. Accordingly, an object of the present invention is to provide an apparatus and method for accurately detecting a reception timing by eliminating the effects of an interference signal or a neighboring signal on a received signal.

Another object of the present invention is to provide an apparatus and method for when a transmitted signal travels along multiple paths, accurately recovering the transmitted signal by accurately estimating received multipath signals.

A further object of the present invention is to provide an apparatus and method for detecting initial errors in a received signal and eliminating the initial errors.

The above objects are achieved by providing a method and apparatus for receiving a transmitted signal by accurately estimating spread delays of multiple paths along which the transmitted signal travels in a mobile communication system using a rake receiver with a plurality of fingers.

According to one aspect of the present invention, in the receiving method, the energy of a first path earlier than a predetermined path and the energy of a second path later than the predetermined path are calculated. The predetermined path is estimated using time points at which the energy of the first path is equal to the energy of the second path. The accuracy of the estimated path is verified using a ratio between the energy of earlier paths other than the predetermined path and the first path and the energy of later paths other than the predetermined path and the second path. Only a signal from the verified path is output.

According to another aspect of the present invention, in the receiving apparatus, a timing error detector detects the timing of a predetermined path by calculating the energy of a first path earlier than the predetermined path and calculating the energy of a second path later than the predetermined path, a verifier verifies the accuracy of the estimated path, and a controller controls the timing detection of the timing error detector, determines whether the output of the verifier falls in a predetermined range, and controls the output of the timing error detector to be output according to the determination result.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional Timing Error Detector (TED) for detecting a timing error;

FIG. 2 is a graph illustrating time points set for timing error detection if a signal is received from a single path;

FIG. 3 is a graph illustrating timing error detection failure if a signal is received from two paths;

FIG. 4 is a graph illustrating time points set for timing error detection according to an embodiment of the present invention;

FIG. 5 is a block diagram of a TED according to an embodiment of the present invention;

FIG. 6 is a flowchart illustrating the operation of the TED according to an embodiment of the present invention;

FIG. 7 illustrates the structure of a finger having the TED according to an embodiment of the present invention;

FIG. 8 is a flowchart illustrating the operation of the finger according to an embodiment of the present invention;

FIG. 9 is a graph illustrating two signals spaced from each other by one chip;

FIG. 10 is a graph illustrating reception of the signal illustrated in FIG. 9 in the conventional TED;

FIG. 11 is a graph illustrating reception of the signal illustrated in FIG. 9 in the TED according to an embodiment of the present invention;

FIG. 12 is a graph illustrating elimination of an initial error in two received signals according to an embodiment of the present invention;

FIG. 13 is a graph illustrating four signals spaced from each other by one chip;

FIG. 14 is a graph illustrating reception of the signal illustrated in FIG. 13 in the conventional TED;

FIG. 15 is a graph illustrating reception of the signal illustrated in FIG. 13 in the TED according to an embodiment of the present invention; and

FIG. 16 is a graph illustrating elimination of an initial error in four received signals according to an embodiment of the present invention.

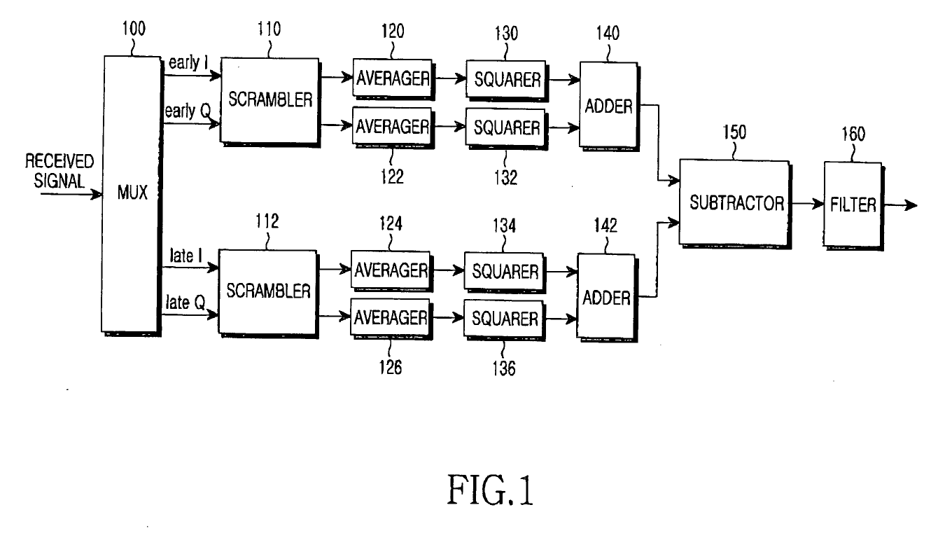

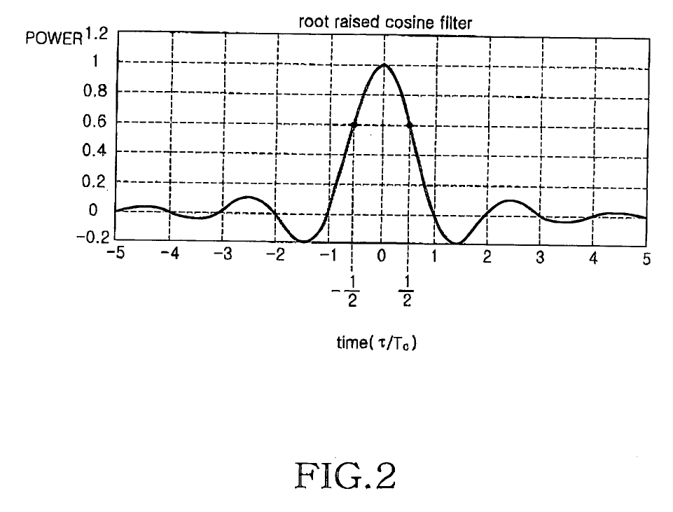

Throughout the drawings, it should be noted that the same or similar elements are denoted by like reference numerals.

### DETAILED DESCRIPTION OF THE PREFERRED EMBODIMENT

An embodiment of the present invention will be described herein below with reference to the accompanying drawings. In the following description, well-known functions or constructions are not described in detail for conciseness.

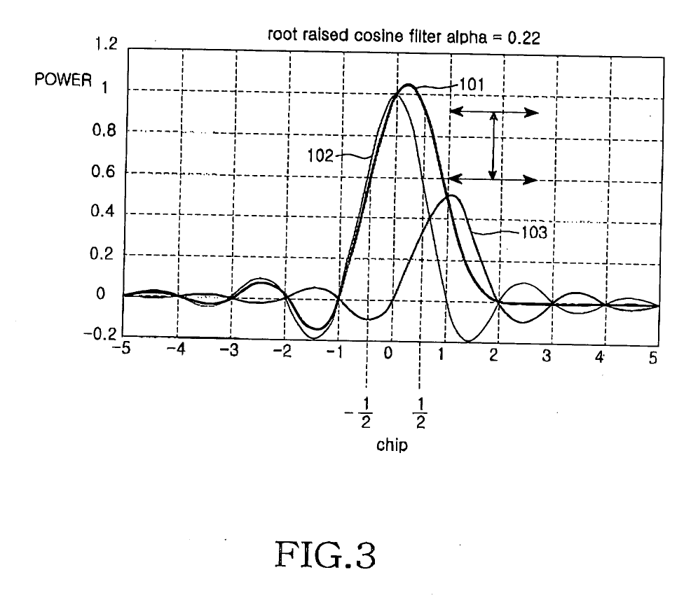

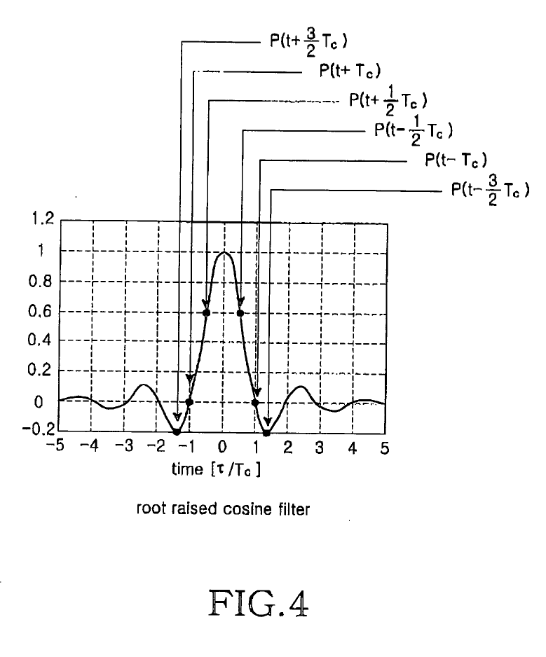

FIG. 4 is a graph illustrating time points at which the energy of a received signal is measured. Referring to FIG. 4, the energy of the received signal is measured at six time points. Consideration is given to only time points having the same energy value, earlier and later than a predetermined time point in a conventional Early Late Timing Error Detector (EL-TED) method. However, if a signal received within several chips from the received signal serves as interference, the reception time of the received signal cannot be detected accurately due to the interference signal, as described before with reference to FIG. 3.

In accordance with an embodiment of the present invention, once the time points having the same energy value, earlier and later than the predetermined time point are detected, additional time points are taken for energy detection. If the detected energy is below a threshold, it is determined that interference has no effect on the received signal.

To detect the interference signal in the received signal, a multipath searcher (MPS) can be used. However, the embodiment of the present invention detects a neighboring signal or an interference signal without using the MPS. The following equation represents an energy ratio of the received signal between particular time points.

$${\sum }^{M} \vert \frac{\vert E ( t + \frac{3}{2} {T}_{c} ) \vert - \vert E ( t + {T}_{c} ) \vert}{\vert E ( t - \frac{3}{2} {T}_{c} ) \vert - \vert E ( t - {T}_{c} ) \vert} \vert \qquad ( 15 )$$

where M is a predetermined time period. As noted from Eq. (15), the energy of the received signal is detected at four time points. A ratio of the energy difference between two earlier time points to the energy difference between two later time points is calculated. While the energy is measured at 1-chip and 3/2-chip earlier time points and at 1-chip and 3/2-chip later time points in the case illustrated by Eq. (15), the time points are freely determined according to user selection. In general, when neither a neighboring signal nor an interference signal is present, Eq. (15) results in a value approximate to 1.

If the value of Eq. (15) is within a predetermined range, it is determined that the received signal is not influenced by either the neighboring signal or the interference signal. The S curve of the received signal is symmetrical with respect to the predetermined time point. Thus, neither the neighboring signal nor the interference signal affects the received signal. The predetermined range is given as

$${δ}_{i} {,}_{1} \leq {\sum }^{M} \vert \frac{\vert E ( t + \frac{3}{2} {T}_{c} ) \vert - \vert E ( t + {T}_{c} ) \vert}{\vert E ( t - \frac{3}{2} {T}_{c} ) \vert - \vert E ( t - {T}_{c} ) \vert} \vert \leq {δ}_{i} {,}_{2} \qquad ( 16 )$$

where δᵢ is derived from the nature of the root-raised cosine filter, I denoting a finger index. How δᵢ is achieved will be described. Typically, the MPS provides information with +1/2 and −1/2 chip errors to the TED all the time. For example, if an initial error is +1/2 chip in FIG. 3, the time points for energy detection are changed in Eq. (4) and the resulting value of Eq. (4) is used as a determinant of δᵢ. In the presence of Additive White Gaussian Noise (AWGN) and a radio channel, the determinant may vary greatly. Therefore, δᵢ is selected to be less than the determinant. eₛ is easily obtained through sufficient simulations. Also, it can be changed in software.

If the value of Eq. (15) falls into the range of Eq. (16), which indicates that there are no effect from a neighboring signal or an interference signal, the TED operates in a conventional manner. On the contrary, if it is beyond the range, this indicates a timing error other than a timing error expected from a normal S curve has been generated by the neighboring signal or the interference signal. Therefore, a value resulting from the normal TED operation cannot be still used. In the case where the value of Eq. (15) is within the predetermined range defined by Eq. (16), a non-coherent TED error is detected by

$${{TE}_{NC} = {E [ \vert a \vert ]}^{2} {\sum }_{j = 1 , 2} \cdot {( - 1 )}^{j + 1} \cdot {\vert C \cdot {R}_{g} ( \frac{{T}_{c}}{H} + \hat{τ} - τ ) \vert}^{2} \vert}_{H = - 2 for j = 2}^{H = 2 , for j = 1} \qquad ( 17 )$$

and a coherent TED error is detected by

$${{TE}_{C} = {E [ \vert a \vert ]}^{2} {\sum }_{j = 1 , 2} {( - 1 )}^{j + 1} \cdot {\hat{C}}_{m} * C \cdot {\vert {R}_{g} ( \frac{{T}_{c}}{H} + \hat{τ} - τ ) \vert}^{2} \vert}_{H = - 2 , for j = 2}^{H = 2 , for j = 1} \qquad ( 18 )$$

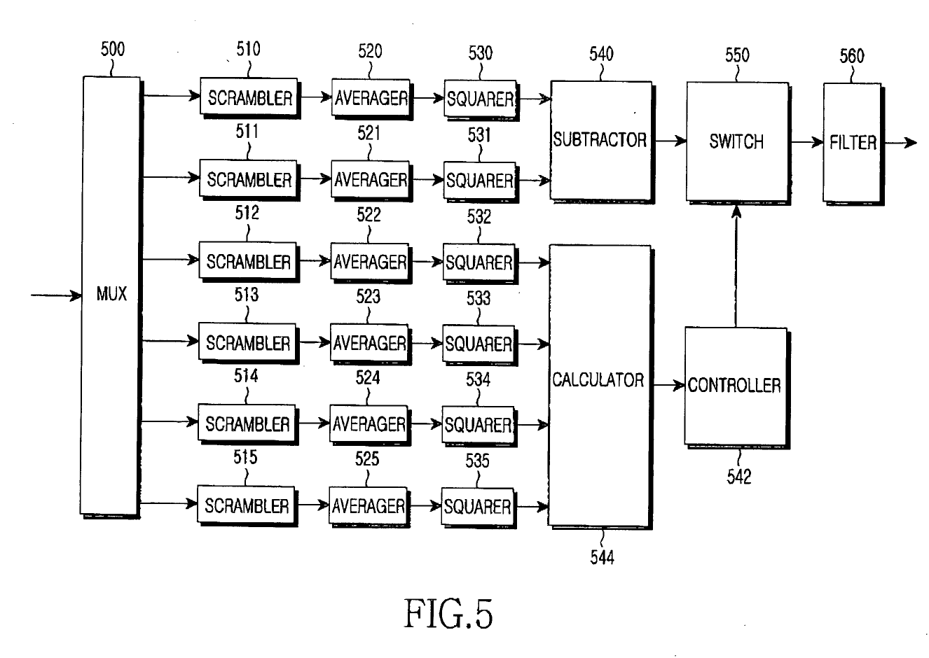

FIG. 5 is a block diagram of a TED according to an embodiment of the present invention. Referring to FIG. 5, the TED comprises a MUX 500, scramblers 510 to 515, averagers 520 to 525, squarers 530 to 535, a subtractor 540, a switch 550, a filter 560, a controller 542, and a calculator 544. Only components related to the embodiment of the present invention are illustrated in FIG. 5, although the TED may further comprise components other than those illustrated.

The MUX 500 multiplexes a received signal and outputs signals earlier and later than a predetermined time point. The scrambler 510 receives a 1/2-chip earlier signal and the scrambler 511 receives a 1/2-chip later signal. The scramblers 510 and 511 scramble the input signals with a predetermined scrambling code. While the 1/2-chip earlier signal and the 1/2-chip later signal each are branched into an I signal and a Q signal, they are illustrated to include the I and Q signals in FIG. 5, for conciseness. The scrambled signals are applied to the input of the squarers 530 and 531 through the averagers 520 and 521. The subtractor 540 calculates the difference between the square values output from the squarers 530 and 531. The switch 550 switches the difference to the filter 560 under the control of the controller 542.

In the mean time, the MUX 500 outputs 1-chip and 3/2-chip earlier signals and 1-chip and 3/2-chip later signals to the scrambles 512 to 515. That is, the scrambler 512 receives the 3/2-chip earlier signal, the scramble 513 receives the 1-chip earlier signal, the scrambler 514 receives the 1-chip later signal, and the scrambler 515 receives the 3/2-chip later signal. The scramblers 512 to 515 operate in the same manner as the scramblers 510 and 511. The scrambled signals are fed to the squarers 532 to 535 through the averagers 522 to 525.

The calculator 544 calculates Eq. (15). The controller 542 determines whether the value of Eq. (15) falls into the range defined by Eq. (16). Alternatively, a verifier determines whether the value of Eq. (15) falls into the range and notifies the controller 542 of the determination result.

If the value falls in the range, the controller 542 turns on the switch 550 so that the difference output from the subtractor 540 is fed to the filter 560, and the filter 560 detects the reception time of the received signal.

On the contrary, if the value of Eq. (15) is beyond the range, the controller 542 turns off the switch 550.

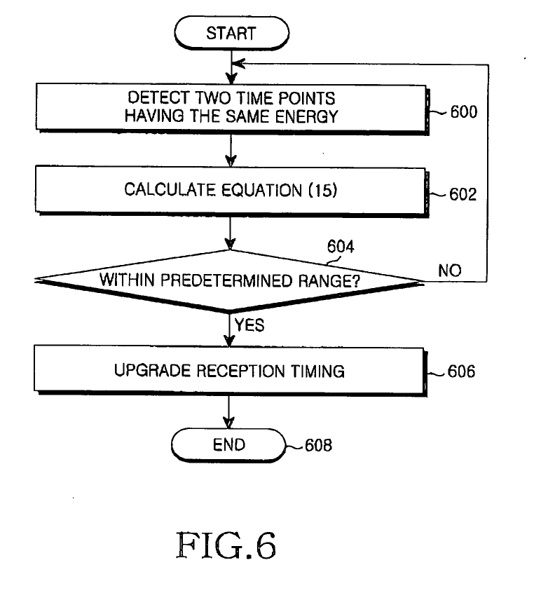

FIG. 6 is a flowchart illustrating the operation of the EL-TED according to an embodiment of the present invention. Referring to FIG. 6, the EL-TED detects two time points having the same energy levels with respect to a predetermined time point, as described with reference to FIG. 5, in step 600. In step 602, the EL-TED calculates Eq. (15) using the detected two time points. The mean time point between the two time points is calculated and four time points spaced from the mean time point by a predetermined value are detected. Using the energy levels of the four time points, Eq. (16) is calculated. The predetermined value can be adjusted according to user selection. In step 604, the EL TED determines if the value of Eq. (15) falls into a predetermined range. If the value falls into the predetermined range, the EL TED proceeds to step 606. Otherwise, it returns to step 600. In step 606, the EL TED detects a time point having the highest energy value using the conventional time error detection operation and recovers the received signal using a signal at the detected time point. By repeating this procedure, the receiver can detect an accurate reception timing of the received signal.

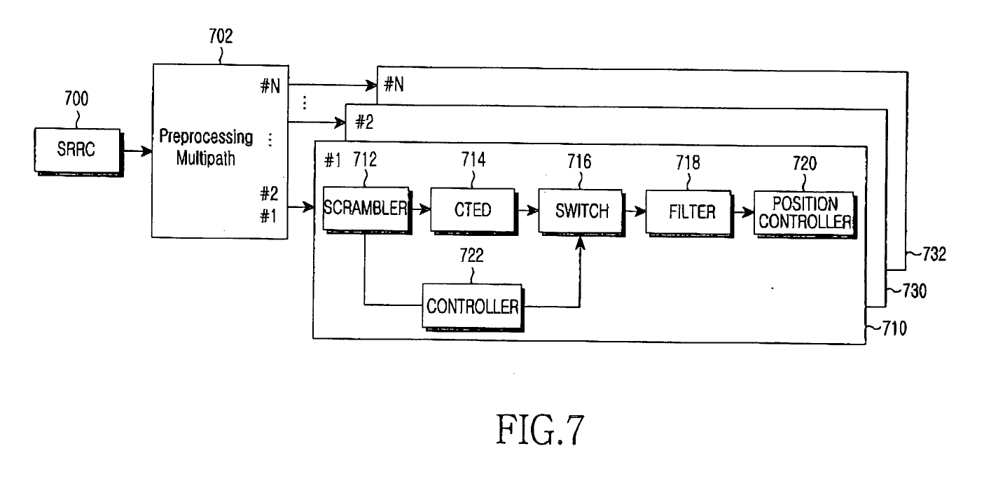

FIG. 7 illustrates the structure of a finger including the TED in a rake receiver according to an embodiment of the present invention. Referring to FIG. 7, the rake receiver comprises a squared root-raised cosine filter (SRRC) 700, a preprocessor & multipath detector 702, and a plurality of fingers 710, 730 and 732. The finger 710 includes a scrambler 712, a conventional timing error detector (CTED) 714, a switch 716, a filter 718, a position controller 720, and a controller 722. The SRRC 700 provides a received signal to the preprocessor & multipath detector 702. The preprocessor & multipath detector 702 assign one path to each finger. In the case illustrated in FIG. 7, N paths exist. Hereinbelow, the operation of the finger 710 (finger # 1) will be described.

The scrambler 712 multiplies the received signal by a predetermined scrambling code, for scrambling. The controller 722 determines whether the scrambled signal satisfies the condition of Eq. (16). When the condition is satisfied, the controller 722 turns on the switch 716. As the switch 716 turns on, the filter 718 filters the output of the CTED 714 and the position controller 720 adjusts a reception timing according to the filter output.

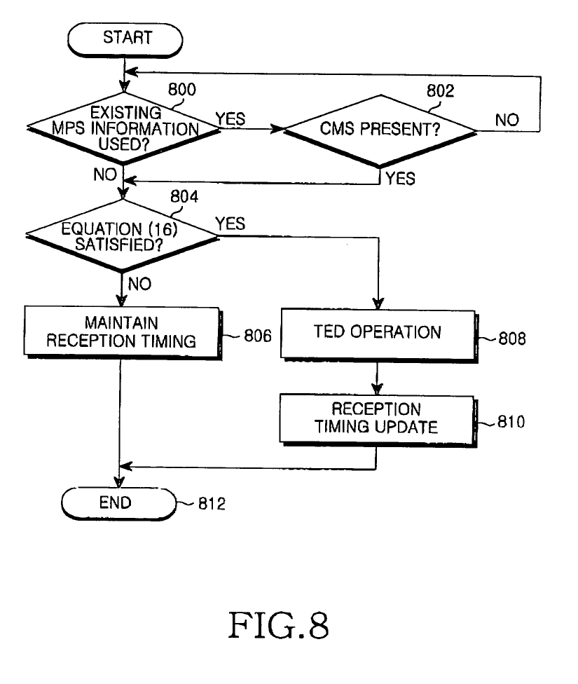

FIG. 8 is a flowchart illustrating the operation of the finger having the TED according to an embodiment of the present invention.

Referring to FIG. 8, the finger determines whether to use MPS information or not in step 800. If the MPS information is used, the finger proceeds to step 802. Otherwise, it goes to step 804. In step 802, the finger determines whether there is a Common Signaling Mode (CSM) signal for the received signal using the MPS information. In the presence of the CSM signal, the finger goes to step 804. In the absence of the CSM signal, the finger returns to step 800.

In step 804, the finger determines whether the received signal satisfies the condition of Eq. (16). If the condition is satisfied, the finger proceeds to step 808. If it is not, the finger goes to step 806. The TED performs a timing error detection operation and the position controller updates a reception timing according to the output of the TED in step 808. On the other hand, the finger maintains the reception timing in step 806. Steps 804 through 810 are performed for a predetermined time period. Upon detection of a new path for the time period, the finger returns to step 800.

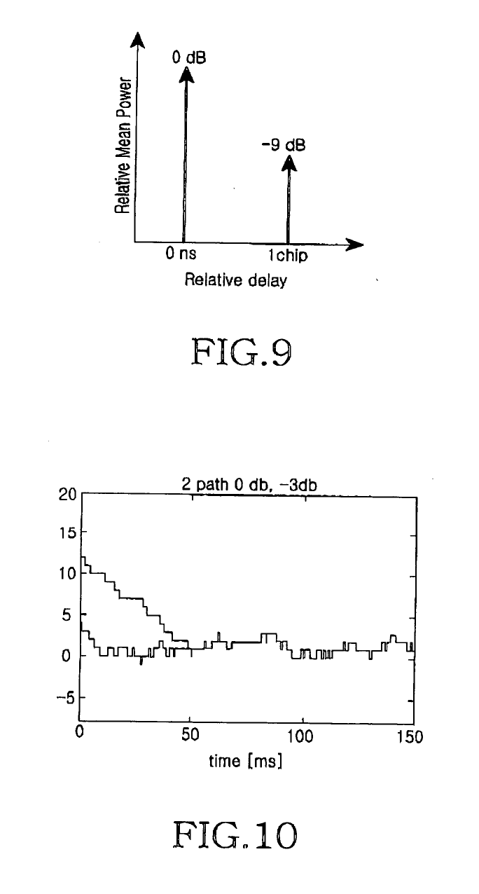

FIG. 9 is a graph illustrating signals spaced from each other at one chip interval and FIG. 10 is a graph illustrating reception of the signals illustrated in FIG. 9 in the conventional EL TED. As noted from FIG. 10, input signals for the fingers are converged to one signal after a predetermined time point because the 1-chip spaced signals each interfere with the other signals, as interference or neighboring signals.

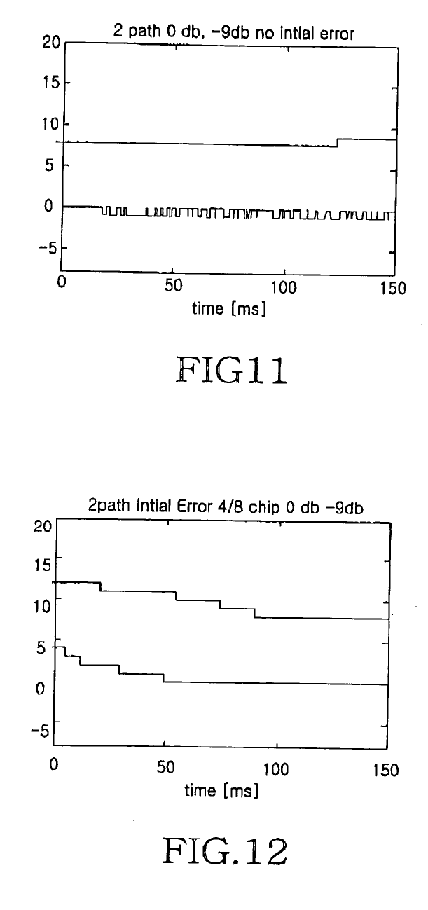

FIG. 11 is a graph illustrating reception of the 1-chip spaced signals illustrated in FIG. 9 in the EL TED according to an embodiment of the present invention. Unlike the conventional EL TED, the EL TED in an embodiment of the present invention accurately tracks the received two signals. FIG. 12 is a graph illustrating the operation of the EL TED when the received signals have initial errors according to an embodiment of the present invention. Referring to FIG. 12, the EL TED eliminates the initial errors over time.

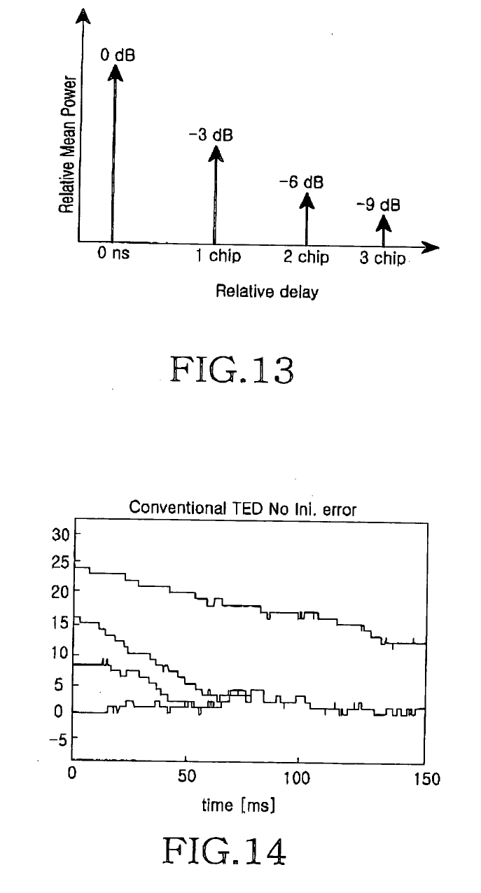

FIG. 13 is a graph illustrating four signals spaced from each other at one chip interval and FIG. 14 is a graph illustrating reception of the signals illustrated in FIG. 13 in the conventional EL TED. As noted from FIG. 14, input signals for the fingers converge to one signal after a predetermined time point because the 1-chip spaced signals each interfere with the other signals, as interference or neighboring signals.

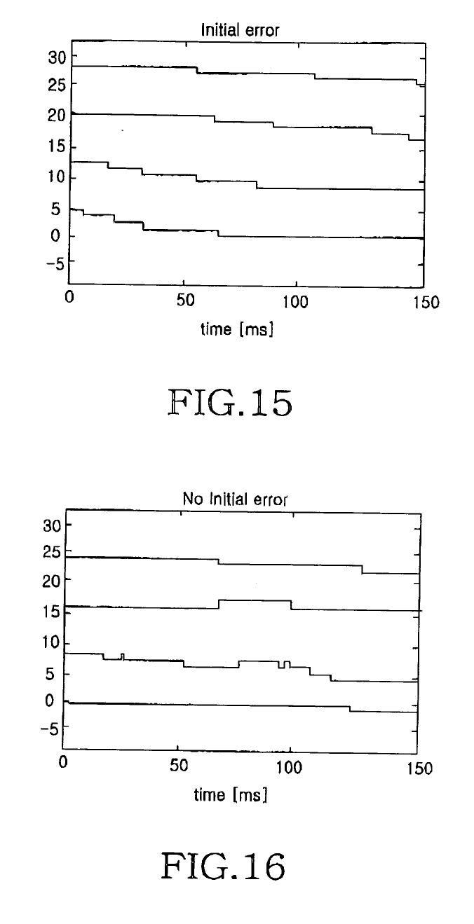

FIG. 15 is a graph illustrating reception of the 1-chip spaced signals illustrated in FIG. 13 in the EL TED according an embodiment of the present invention. Unlike the conventional EL TED, the EL TED according to an embodiment of the present invention accurately tracks the received two signals. FIG. 16 is a graph illustrating the operation of the EL TED when the received signals have initial errors according to an embodiment of the present invention. Referring to FIG. 16, the EL TED eliminates the initial errors over time.

In accordance with an embodiment of the present invention as described above, signals received from neighboring paths are accurately estimated and the phenomenon of convergence of finger signals corresponding to the multiple paths is prevented. Also, initial errors are eliminated from the received signals.

While the invention has been shown and described with reference to a certain preferred embodiment thereof, it should be understood by those skilled in the art that various changes in form and details may be made therein without departing from the spirit and scope of the invention as defined by the appended claims.

1. A method of receiving a transmitted signal by accurately estimating spread delays of multiple paths along which the transmitted signal travels in a mobile communication system using a rake receiver having a plurality of fingers, comprising the steps of:
calculating the energy of a first path earlier than a predetermined path;
calculating the energy of a second path later than the predetermined path;
estimating the predetermined path using time points at which the energy of the first path is equal to the energy of the second path;
verifying the accuracy of the estimated path using a ratio between the energy of earlier paths other than the predetermined path and the first path and the energy of later paths other than the predetermined path and the second path; and
outputting only a signal from the verified path.

2. The method of claim 1, wherein the verifying step comprises the steps of:
calculating the ratio between the energy of the earlier paths and the energy of the later paths; and
determining whether the ratio falls in a predetermined range.

3. The method of claim 2, wherein the range is set in consideration of information having +1/2 and −1/2 chip errors that a multipath searcher transmits to a timing error detector.

4. The method of claim 2, wherein the ratio calculating step further comprises the step of:
calculating the difference between the energy of a third path earlier than the predetermined path and the energy of a fourth path later than the third path and earlier than the predetermined path, as the energy of the earlier paths.

5. The method of claim 2, wherein the ratio calculating step further comprises the step of:
calculating the difference between the energy of a fifth path later than the predetermined path and the energy of a sixth path earlier than the fifth path and later than the predetermined path, as the energy of the later paths.

6. The method of claim 4, wherein the third path and the fifth path are spaced from the predetermined path by a first equal interval, and the fourth path and the sixth path are spaced from the predetermined path by a second equal interval.

7. The method of claim 5, wherein the third path and the fifth path are spaced from the predetermined path by a first equal interval, and the fourth path and the sixth path are spaced from the predetermined path by a second equal interval.

8. An apparatus for receiving a transmitted signal by accurately estimating spread delays of multiple paths along which the transmitted signal travels in a mobile communication system using a rake receiver having a plurality of fingers, comprising:
a timing error detector for detecting the timing of a predetermined path by calculating the energy of a first path earlier than the predetermined path and calculating the energy of a second path later than the predetermined path;
a verifier for verifying the accuracy of the estimated path; and
a controller for controlling the timing detection of the timing error detector, determining whether the output of the verifier falls in a predetermined range, and controlling the output of the timing error detector to be output according to the determination result.

9. The apparatus of claim 8, wherein the verifying step comprises the steps of:
calculating the energy of earlier paths other than the predetermined path and the first path and the energy of later paths other than the predetermined path and the second path;
calculating the ratio between the energy of the earlier paths and the energy of the later paths; and
determining whether the ratio falls into a predetermined range.

10. The apparatus of claim 9, wherein the verifier determines the range in consideration of information having +1/2 and −1/2 chip errors that a multipath searcher transmits to the timing error detector.

11. The apparatus of claim 9, wherein the verifies calculates as the energy of the earlier paths the difference between the energy of a third path earlier than the predetermined path and the energy of a fourth path later than the third path and earlier than the predetermined path.

12. The apparatus of claim 9, wherein the verifier calculates as the energy of the later paths the difference between the energy of a fifth path later than the predetermined path and the energy of a sixth path earlier than the fifth path and later than the predetermined path.

13. The apparatus of claim 11, wherein the verifier sets the third path and the fifth path to be spaced from the predetermined path by a first equal interval, and sets the fourth path and the sixth path to be spaced from the predetermined path by a second equal interval.

14. The apparatus of claim 12, wherein the verifier sets the third path and the fifth path to be spaced from the predetermined path by a first equal interval, and sets the fourth path and the sixth path to be spaced from the predetermined path by a second equal interval.
